(19) United States
(12) Patent Application Publication
(10) Pub. No.: US 2025/0122064 A1
(43) Pub. Date: Apr. 17, 2025

(54) PRYBAR FOOT ATTACHMENT

(71) Applicant: Snap-on Incorporated, Kenosha, WI (US)

(72) Inventors: Craig Bashleben, Winthrop Harbor, IL (US); John R. Maniscalco, Oak Creek, WI (US)

(73) Assignee: Snap-on Incorporated, Kenosha, WI (US)

(21) Appl. No.: 18/380,402

(22) Filed: Oct. 16, 2023

(51) Int. Cl. B66F 15/00; B66F 13/00

(52) U.S. Cl. CPC B66F 15/00; B66F 13/00

(57) ABSTRACT

An attachment for a prybar including a base portion having a bottom surface and an interface surface opposite the bottom surface, and opposing first and second sides that extend upwardly from the base portion and define a channel therebetween. The channel is adapted to receive a prybar, and a pin is disposed in first and second apertures in the respective first and second sides to retain the attachment on the prybar. The attachment provides a fulcrum surface for the prybar that may be positioned anywhere along a length of a prybar shaft of the prybar.

### TECHNICAL FIELD OF THE INVENTION

The present invention relates generally to an attachment for a prybar. More particularly, the present invention relates to a prybar attachment adapted to provide a fulcrum at any point along a prybar shaft.

### BACKGROUND OF THE INVENTION

Levers are machines commonly used to provide a mechanical advantage when lifting or moving the load. A first force is applied to one end of the lever, and the lever pivots at a fulcrum providing a second force on the load at the other end of the lever. The location of the first force, load, and fulcrum will determine the type of lever and amount of mechanical advantage of the machine.

A common type of lever is a prybar. Prybars generally include a pry portion and a prybar shaft, which acts a lever. Typically, the pry portion is placed in a desired location under a load and the prybar pivots about a fulcrum along that prybar shaft that is in contact with a grounding surface. However, during use of a prybar, the prybar may slip against the grounding surface (the surface upon which the prybar pivots or pushes against) or even crush or damage the grounding surface. The grounding surface is typically miscellaneous material. For example, a piece of miscellaneous or scrap material may be placed under the prybar shaft to create a new fulcrum point at a different location along the prybar shaft.

Typically, prybars have a bend between the pry portion and the prybar shaft to define the fulcrum, and the prybar pivots on this bend, but it is sometimes desirable to pivot a prybar about another position along the prybar shaft.

### SUMMARY OF THE INVENTION

The present invention relates broadly to an attachment for a prybar. The attachment may prevent slipping between a grounding surface and the prybar. The attachment may also prevent crushing or damage to the grounding surface as the attachment may provide a larger surface area that applies force to the grounding surface compared to a portion of the prybar. The attachment may also provide another fulcrum point for the prybar at a desired location along a prybar shaft of the prybar.

In an embodiment, the present invention broadly relates to an attachment for a prybar, and the attachment includes a base portion having a bottom surface and an interface surface opposite the bottom surface, opposing first and second sides extending upwardly from the base portion and cooperatively forming a channel between the first and second sides that is adapted to receive the prybar, and a fastener coupling the first and second sides together and extending across the channel. The attachment may also include first and second apertures in the respective first and second sides, and the fastener may be disposed in the first and second apertures.

In another embodiment, the present invention broadly relates to an attachment for a prybar, and the attachment includes a base portion having a bottom surface and an interface surface opposite the bottom surface, opposing first and second sides extending upwardly from the base portion and cooperatively forming a channel between the first and second sides that is adapted to receive a prybar, first and second recesses disposed in the respective first and second sides, wherein a first width is formed between the first and second sides at the first and second recesses, a second width is formed between the first and second sides at a remainder of the channel, wherein the first width is greater than the second width, and a fastener coupling the first and second sides together and extending across the channel. The attachment may also include first and second apertures in the respective first and second sides, and the fastener may be disposed in the first and second apertures.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a perspective view of a prybar attachment, including an embodiment of the present invention.

FIG. 2 is a perspective view of the prybar attachment of FIG. 1, showing the attachment attached to an exemplar prybar in a first position.

FIG. 3 is a plan, side view of the prybar attachment of FIG. 2, showing the attachment attached to an exemplar prybar in a first position.

FIG. 4 is a perspective view of the prybar attachment of FIG. 1, showing the attachment attached to an exemplar prybar in a second position.

FIG. 5 is a plan, side view of the prybar attachment of FIG. 4, showing the attachment attached to an exemplar prybar in a second position.

FIG. 6 is a perspective view of another embodiment of a prybar attachment.

FIG. 7 is a perspective view of the prybar attachment of FIG. 6, showing the attachment attached to an exemplar prybar in a first position.

FIG. 8 is a plan, side view of the prybar attachment of FIG. 7, showing the attachment attached to an exemplar prybar in a first position.

FIG. 9 is a perspective view of another embodiment of a prybar attachment.

### DETAILED DESCRIPTION OF THE INVENTION

While the present invention is susceptible of embodiments in many different forms, there is shown in the drawings, and will herein be described in detail, embodiments of the invention, including a preferred embodiment, with the understanding that the present disclosure is to be considered as an exemplification of the principles of the present invention and is not intended to limit the broad aspect of the invention to any one or more embodiments illustrated herein. As used herein, the term “present invention” is not intended to limit the scope of the claimed invention, but is instead used to discuss exemplary embodiments of the invention for explanatory purposes only.

The present invention relates broadly to a prybar attachment that includes a base portion with a bottom surface and an interface surface, side members extending upwardly from the base portion on opposing sides of the interface surface, and a channel formed between the side members and that is adapted to receive a prybar. The attachment of the present invention is intended to be used with typical prybars. The attachment also includes a removable or permanent pin coupling the side members together. When the pin is removable, the pin may be inserted through the side members after a prybar is received in the channel, to retain the attachment on the prybar and prevent the prybar from falling or lifting out of the attachment. The attachment is slidably adjustable along a prybar shaft of the prybar and can be positioned at any desired location along the prybar shaft to define the fulcrum and location that the prybar abuts a grounding surface.

The bottom surface is adapted to contact or rest on a grounding surface, and provides a larger surface area, compared to a typical fulcrum of a prybar or a prybar shaft, and reduces the chance of damaging the grounding surface. The bottom surface also reduces the risk of the attachment inadvertently sliding during use of the prybar. The bottom surface may be a flat surface or a serrated surface to increase friction between the bottom surface and the grounding surface. Alternatively, the bottom surface may be an arcuate surface or another shaped surface suitable to act as a fulcrum surface against the grounding surface.

The interface surface may include a raised portion upon which the prybar pivots. The raised portion may be an arcuate surface or another shaped surface suitable to act as a fulcrum surface for the prybar. The interface surface may also optionally include serrations or other means to increase friction against the prybar shaft. In other embodiments, the interface surface may be a flat surface, and can include serrations, or other surface features or treatments to provide a surface suitable for gripping or increasing friction against the prybar shaft. In another embodiment, each of the side members has a cutout or recess forming a channel portion with a larger width that is adapted to receive a pry portion of a typical prybar. This may allow for the prybar to be selectively positioned within the attachment with the fulcrum created by the attachment closer to the pry portion.

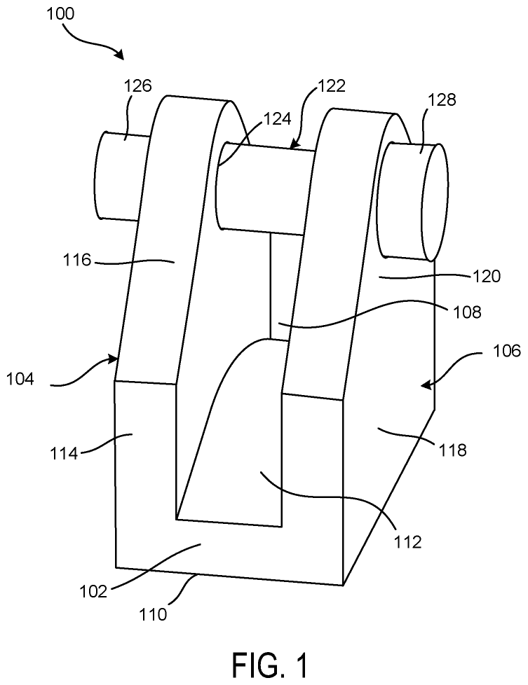

Referring to FIGS. 1-5, an attachment 100 for an exemplar, typical prybar 300 is shown and described. The attachment 100 includes a base portion 102 and opposing first and second sides 104, 106 extending upwardly from the base portion 102. A channel 108 is formed between the first and second sides 104, 106 and is adapted to slidably receive the exemplar prybar 300. The base portion 102 includes a bottom surface 110 on a bottom side of the base portion 102, and an interface surface 112 on a top side of the base portion 102, opposite the bottom side, between the first and second sides 104, 106. The bottom surface 110 is adapted to contact or rest on a grounding surface, and provides a larger surface area defining the fulcrum, compared to a conventional bend of prybar shaft 302 of a typical prybar 300, and reduces the chance of damaging the grounding surface due to the larger surface area of the bottom surface 110 that contacts the grounding surface. The bottom surface 110 also reduces the risk of the pry bar 300 with an attached attachment 100 sliding during use. For example, the bottom surface 110 may be a flat surface or include friction enhancement, such as, for example, a serrated surface, to increase friction between the bottom surface 110 and the grounding surface during use. While the bottom surface 110 is described as flat or serrated, other techniques and/or surface treatments can be used to provide a surface suitable for gripping or increasing friction between the bottom surface 110 and the grounding surface.

The interface surface 112 may also include a raised portion that acts as the fulcrum surface upon which the prybar 300 pivots. In an embodiment, the interface surface 112 may be an arcuate surface. While the interface surface 112 is depicted as arcuate, the interface surface 112 can be any other shape suitable for providing a surface that may act as a fulcrum surface for a prybar, including a flat surface. Further, the interface surface 112 may optionally include serrations, or other surface features or treatments to provide a surface suitable for gripping or increasing friction against the prybar 300. While the attachment is described as used in conjunction with a prybar, the attachment is suitable for use with other tools that may be used as a general lever, such as a bar, pole, rod, crowbar, prybar, etc.

The first and second sides 104, 106 extend substantially vertically upwardly from opposing sides of the base 104, forming the channel 108 between the first and second sides 104, 106. For example, each of the first and second sides 104, 106 may extend substantially perpendicular or at a substantially 90 degree angle with respect to a plane of the base portion 102. The base portion 102 and first and second sides 104, 106 may be a single, monolithic, component, or may be separate components that are coupled together, for example, via fasteners, adhesives, etc.

As illustrated, each of the first and second sides 104, 106 has lower and upper portions. The lower portions may have a same length as the base portion and may be substantially rectangular in shape, and the upper portion may be triangular in shape. For example, the first side 104 includes a first lower portion 114 and a first upper portion 116, and the first upper portion 116 tapers or angles toward a middle of the first side 104. Similarity, the second side 106 includes a second lower portion 118 and a second upper portion 120, and the second upper portion 120 tapers or angles toward a middle of the second side 106. A removable or permanent fastener 122 may couple the first and second upper portions 116, 120 together. For example, each of the first and second sides 104, 106 may also include an aperture adapted to receive the fastener 122. For example, the first side 104 may include a first aperture 124 proximal to an apex portion (or top portion distal to the base portion 102) of the first side 104 (i.e., proximal to an apex portion of the first upper portion 116). Similarly, the second side 106 may include a second aperture (not shown, as is it covered by the fastener 122) proximal to an apex portion (or top portion distal to the base portion 102) of the second side 106 (i.e., proximal to an apex portion of the second upper portion 120).

The fastener 122 helps to retain the prybar 300 in the channel 108 during use of the attachment 100, improving the safety for the user. The fastener 122 may include a shank portion 126 and a head portion 128. The shank portion 126 is disposed through the first and second apertures, extending across the channel 108, with the head portion 128 abutting one of the first and second sides 104, 106. The head portion 128 is generally larger in size or diameter than the first and second apertures, to prevent the fastener 122 from being pushed or inserted, or accidentally moving through the first and second apertures.

In an embodiment, the fastener 122 may be a pin type fastener that is removably insertable into the first and second apertures. The pin type fastener may also include one or more detent balls in the shank portion 126 proximal to an end of the fastener opposite the head portion 128, to assist retaining the fastener in the first and second apertures. In other examples, the fastener 122 may be any other type of fastener that is removably insertable into the first and second apertures. For example, the fastener 122 may be a threaded bolt or screw, cotter pin, cleavis pin, clip, rope, etc. Alternatively, the fastener 122 may not be removable or may be permanent. For example, the fastener 122 can be a pin having opposing ends respectively welded or otherwise permanently connected to the first and second sides 104, 106, and may removably or permanently retain the attachment 100 on the prybar 300.

To slidably dispose the attachment 100 on prybar 300, the fastener 122 is removed from at least one of the first and second apertures, to allow a vertical access to the channel 108. With the fastener 122 removed, the prybar shaft 302 of the prybar 300 can be vertically disposed into the channel 108. The fastener 122 can then be disposed in the first and second apertures, extending across the channel 108 to retain the attachment 100 on the prybar 300. In an embodiment, the channel 108 has a channel width that is greater than a width of the prybar shaft 302 and less than a width of a pry portion 304 of the prybar 300. This allows the attachment 100 to be slidable along the prybar shaft 302, but prevents the pry portion 304 from being horizontally moved through the channel 108. Thus, the attachment 100 is retained from falling off of the prybar 300 vertically by the fastener 122, and horizontally due to the channel width. This also allows a user to couple the attachment 100 to the prybar 300, and pick up or move the combination prybar 300 and attachment 100 without the attachment 100 inadvertently falling off of the prybar 300.

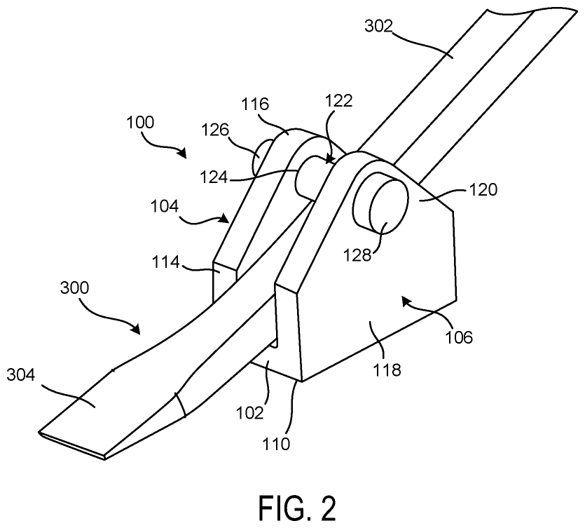

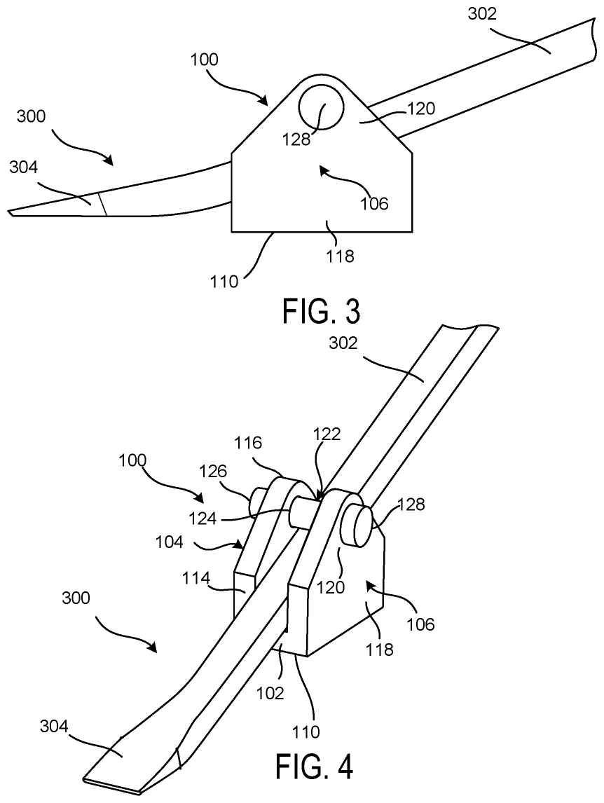

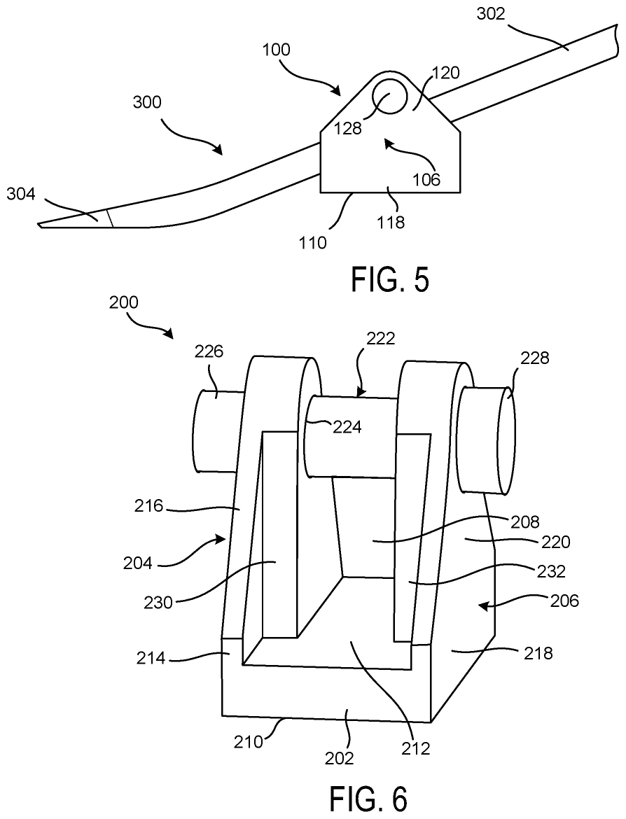

Referring to FIGS. 2-5, the attachment 100 is shown disposed on the prybar 300 in first and second positions. In the exemplar shown in FIGS. 2 and 3, the attachment 100 is selectively positioned along the prybar shaft 302 in an exemplar first position proximal to the pry portion 304. In FIGS. 4 and 5, the attachment 100 is selectively positioned along the prybar shaft 302 in an exemplar second position further away from the pry portion 304, compared to the first portion shown in FIGS. 2 and 3. It will be appreciated that the slidability of the attachment 100 along the prybar shaft 302 allows the user to easily selectively position and/or reposition the attachment 100 relative to the prybar shaft 302 to provide a desired fulcrum surface location for operating the prybar 300.

Referring to FIG. 6-8, another embodiment of the claimed invention is shown and described. The attachment 200 is similar to the attachment 100. For example, the attachment 200 includes a base portion 202 and opposing first and second sides 204, 206 extending upwardly from the base portion 202. A channel 208 is also formed between the first and second sides 204, 206 and is adapted to receive a prybar 300. The base portion 202 includes a bottom surface 210 on a bottom side of the base portion 202, and an interface surface 212 on a top side of the base portion 202, opposite the bottom side, between the first and second sides 206, 206. The bottom surface 210 is adapted to contact or rest on a grounding surface, and provides a larger surface area, compared to a bend or prybar shaft 302 of a typical prybar 300, and reduces the chance of damaging the grounding surface. The bottom surface 210 also reduces the risk of the attachment 200 sliding during use of the prybar 300 and attachment 200. The bottom surface 210 may be a flat surface or friction enhanced, such as with a serrated surface, to increase friction between the bottom surface 210 and the grounding surface. While the bottom surface 210 is described as flat or serrated, other techniques and/or surface treatments can be used to provide a surface suitable for gripping or increasing friction between the bottom surface 210 and the grounding surface.

The interface surface 212 may be flat, or may include a raised portion (similar to the interface surface 112 of attachment 100 described above) that acts as a fulcrum surface upon which the prybar 300 pivots. For example, the interface surface 212 may be an arcuate surface, or any other shape suitable for providing a surface that may act as a fulcrum surface for a prybar, including a flat surface (similar to the interface surface 112 of attachment 100 described above). Further, the interface surface 212 may optionally include serrations, or other surface features or treatments to provide a surface suitable for gripping or increasing friction against the prybar 300.

The first and second sides 204, 206 extend substantially vertically upwardly from opposing sides of the base 204, forming the channel 208 between the first and second sides 204, 206. For example, each of the first and second sides 204, 206 may extend substantially perpendicular or at a substantially 90 degree angle with respect to a plane of the base portion 202. The base portion 202 and first and second sides 204, 206 may be a single, monolithic, component, or may be separate components that are coupled together, for example, via fasteners, adhesives, etc.

As illustrated, each of the first and second sides 204, 206 has lower and upper portions. The lower portions may have a same length as the base portion and may be substantially rectangular in shape, and the upper portion may be triangular in shape. For example, the first side 204 includes a first lower portion 214 and a first upper portion 216, and the first upper portion 216 tapers or angles toward a middle of the first side 204. Similarity, the second side 206 includes a second lower portion 218 and a second upper portion 220, and the second upper portion 220 tapers or angles toward a middle of the second side 206. A removable or permanent fastener 222 may couple the first and second upper portions 216, 220 together. Each of the first and second sides 204, 206 may also include an aperture adapted to receive the fastener 222. For example, the first side 204 may include a first aperture 224 proximal to an apex portion (or top portion distal to the base portion 202) of the first side 204 (i.e., proximal to an apex portion of the first upper portion 216). Similarly, the second side 206 may include a second aperture (not shown, as is it covered by the fastener 222) proximal to an apex portion (or top portion distal to the base portion 202) of the second side 206 (i.e., proximal to an apex portion of the second upper portion 220).

Each of the first and second sides 204, 206 may also include a cutout or recess in or on a front end forming a widened channel portion or channel portion with a larger width than a remainder of the channel portion. This widened channel portion may be adapted to receive the pry portion 304 of the prybar 300 to allow the attachment 200 to be selectively positioned close to an end of the pry portion 304. For example, the first side 204 may include a first recess 230, and the second side 206 may include a second recess 232. It will be appreciated that the attachment 100 may also such a cutout or recess in or on a front end of the first and second sides 104, 106 to form a widened channel portion or channel portion with a larger width than a remainder of the channel portion.

The fastener 222 helps to retain the prybar 300, in the channel 208 during use of the attachment 200, improving the safety for the user. The fastener 222 may include a shank portion 226 and a head portion 228. The shank portion 226 is disposed through the first and second apertures, extending across the channel 208, with the head portion 228 abutting one of the first and second sides 204, 206. The head portion 228 is generally larger in size or diameter than the first and second apertures, to prevent the fastener 222 from being pushed or inserted, or accidentally moving through the first and second apertures.

In an example, the fastener 222 may be a pin type fastener that is removably insertable into the first and second apertures. The pin type fastener may also include one or more detent balls in the shank portion 226 proximal to an end of the fastener opposite the head portion 228, to assist in retaining the fastener in the first and second apertures. In other examples, the fastener 222 may be any other type of fastener that is removably insertable into the first and second apertures. For example, the fastener 222 may be a threaded bolt or screw, cotter pin, cleavis pin, clip, rope, etc. Alternatively, the fastener 222 may not be removable or may be permanent. For example, the fastener 222 can be a pin having opposing ends respectively welded or otherwise permanently connected to the first and second sides 204, 206, and may removably or permanently retain the attachment 200 on the prybar 300.

To slideably dispose the attachment 200 on the prybar 300, the fastener 222 is removed from at least one of the first and second apertures, and moved to allow a vertical access to the channel 208. With the fastener 222 moved, the prybar shaft 302 of the prybar 300 can be vertically disposed into the channel 208. The fastener 222 can then be disposed in the first and second apertures, extending across the channel 208 to retain the attachment 200 on the prybar 300. In an embodiment, the channel 208 has first and second widths. The first width is formed between the first and second sides 204, 206 at the first and second recesses 230, 232, and the second width is formed between the first and second sides 204, 206 at a remainder of the channel 208. The first width is greater than the second width. The first width is also greater than a width of the prybar shaft 302 and a width of a pry portion 304, while the second width is greater than the width of the prybar shaft 302 and less than the width of a pry portion 304 of the prybar 300. This allows for the attachment 200 to be slidable along the prybar shaft 302, but prevents the pry portion 304 from being horizontally moved completely through the channel 108. Thus, the attachment 200 is retained from inadvertently falling off of the prybar 300 by the fastener 222, and horizontally due to the channel width. This allows a user to couple the attachment 200 to the prybar 300, and move the combination prybar 300 and attachment 200 without the attachment 200 inadvertently falling off of the prybar 300.

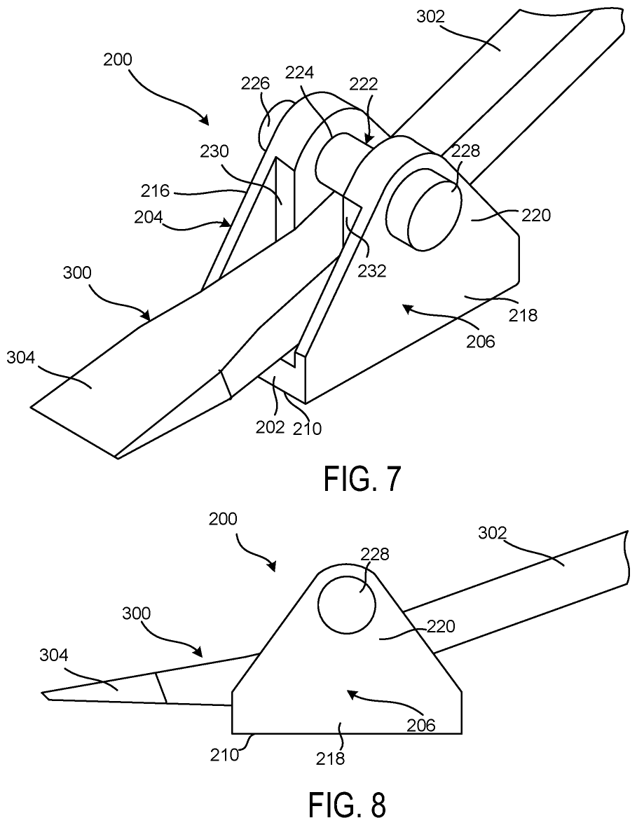

Referring to FIGS. 7 and 8, the attachment 200 is shown disposed on the prybar 300. The attachment 200 is selectively positioned along the prybar shaft 302 proximal to the pry portion 304. However, the attachment 200 is slidable along the prybar shaft 302 to allow the user to selectively position and/or reposition the attachment 200 a provide a desired fulcrum surface for operating the prybar 300. The first and second recesses 230, 232 (forming the first width of the channel 208) also allow the wider pry portion 304 of the prybar 300 to be disposed in the channel 208, to allow the attachment 200 to be position proximal to an end of the pry portion 304.

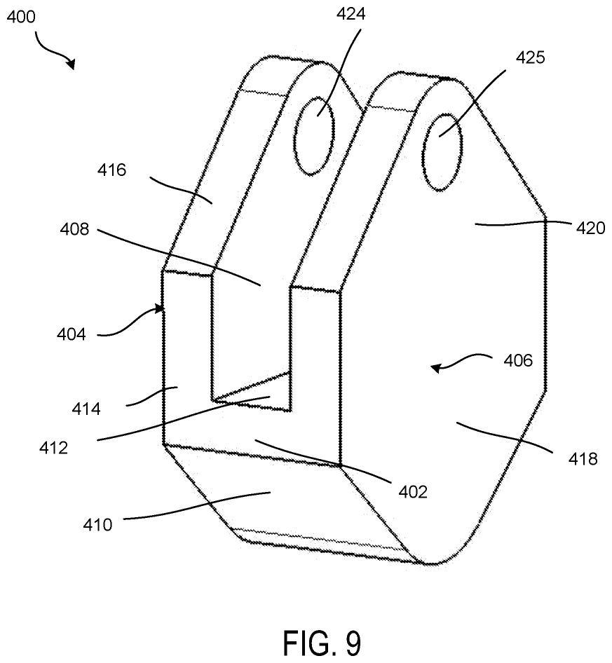

Referring to FIG. 9, another embodiment of the claimed invention is shown and described. The attachment 400 is similar to the attachments 100 and 200. For example, the attachment 400 includes a base portion 402 and opposing first and second sides 404, 406 extending upwardly from the base portion 402. A channel 408 is formed between the first and second sides 404, 406 and is adapted to slidably receive an exemplar prybar, such as prybar 300 shown in FIGS. 2-5, 7 and 8. The base portion 402 includes a bottom surface 410 on a bottom side of the base portion 402, and an interface surface 412 on a top side of the base portion 402, opposite the bottom side, between the first and second sides 404, 406. The bottom surface 410 is adapted to contact or rest on a grounding surface, and provides a larger surface area defining the fulcrum, compared to a conventional bend of prybar shaft 302 of a typical prybar 300, and reduces the chance of damaging the grounding surface due to the larger surface area of the bottom surface 410 that contacts the grounding surface. The bottom surface 410 also reduces the risk of the pry bar 300 with an attached attachment 400 sliding during use. In this embodiment, the bottom surface 410 has an arcuate convex geometry to create a fulcrum point. The bottom surface 410 may be smooth or include friction enhancement, such as, for example, serrations, or other surface features or treatments to provide a surface suitable for gripping or increasing friction between the bottom surface 410 and the grounding surface during use. The bottom surface 410 may or may not have sharp edges to limit damage to grounding surface during actuation of prybar.

The interface surface 412 may be flat, or it may include a raised portion (similar to the interface surface 112 of attachment 100 described above) that acts as the fulcrum surface upon which the prybar 300 pivots. For example, the interface surface 412 may be an arcuate surface, or any other shape suitable for providing a surface that may act as a fulcrum surface for a prybar, including a flat surface (similar to the interface surface 112 of attachment 100 described above). Further, the interface surface 412 may optionally include serrations, or other surface features or treatments to provide a surface suitable for gripping or increasing friction against the prybar 300.

The first and second sides 404, 406 extend substantially vertically upwardly from opposing sides of the base 404, forming the channel 408 between the first and second sides 404, 406. For example, each of the first and second sides 404, 406 may extend substantially perpendicular or at a substantially 90 degree angle with respect to a plane of the base portion 402. The base portion 402 and first and second sides 404, 406 may be a single, monolithic, component, or may be separate components that are coupled together, for example, via fasteners, adhesives, etc.

As illustrated, each of the first and second sides 404, 406 has lower and upper portions. The lower portions may have a same length as the base portion and may be substantially rectangular in shape, and the upper portion may be triangular in shape. For example, the first side 404 includes a first lower portion 414 and a first upper portion 416, and the first upper portion 416 tapers or angles toward a middle of the first side 404. Similarity, the second side 406 includes a second lower portion 418 and a second upper portion 420, and the second upper portion 420 tapers or angles toward a middle of the second side 406. A removable or permanent fastener (not shown), such as the fastener 122 or 222 described above, may couple the first and second upper portions 416, 420 together. Each of the first and second sides 404, 406 may include an aperture adapted to receive a fastener 422. For example, the first side 404 may include a first aperture 424 proximal to an apex portion (or top portion distal to the base portion 402) of the first side 404 (i.e., proximal to an apex portion of the first upper portion 416). Similarly, the second side 406 may include a second aperture 425 proximal to an apex portion (or top portion distal to the base portion 402) of the second side 406 (i.e., proximal to an apex portion of the second upper portion 420). Each of the first and second sides 404, 406 may also include a cutout or recess (as described above in connection with the attachment 200) in or on a front end forming a widened channel portion or channel portion with a larger width than a remainder of the channel portion.

The fastener (not shown), such as the fastener 122 or 222 described above, may couple the first and second sides 404, 406 together, and help to retain the prybar 300 in the channel 408 during use of the attachment 400, improving the safety for the user. For example, the fastener may include a shank portion and a head portion. The shank portion may be disposed through the first and second apertures, extending across the channel 408, with the head portion abutting one of the first and second sides 404, 406. The head portion is generally larger in size or diameter than the first and second apertures, to prevent the fastener from being pushed or inserted, or accidentally moving through the first and second apertures.

In an embodiment, the fastener may be a pin type fastener that is removably insertable into the first and second apertures. The pin type fastener may also include one or more detent balls in the shank portion proximal to an end of the fastener opposite the head portion, to assist retaining the fastener in the first and second apertures. In other examples, the fastener may be any other type of fastener that is removably insertable into the first and second apertures. For example, the fastener may be a threaded bolt or screw, cotter pin, cleavis pin, clip, rope, etc. Alternatively, the fastener may not be removable or may be permanent. For example, the fastener can be a pin having opposing ends respectively welded or otherwise permanently connected to the first and second sides 404, 406, and may removably or permanently retain the attachment 400 on the prybar 300.

To slidably dispose the attachment 400 on prybar 300, the fastener is removed from at least one of the first and second apertures, to allow a vertical access to the channel 408. With the fastener removed, the prybar shaft 302 of the prybar 300 can be vertically disposed into the channel 408. The fastener can then be disposed in the first and second apertures, extending across the channel 408 to retain the attachment 400 on the prybar 300. In an embodiment, the channel 408 has a channel width that is greater than a width of the prybar shaft 302 and less than a width of a pry portion 304 of the prybar 300. This allows the attachment 400 to be slidable along the prybar shaft 302, but prevents the pry portion 304 from being horizontally moved through the channel 408. Thus, the attachment 400 is retained from falling off of the prybar 300 vertically by the fastener, and horizontally due to the channel width. This also allows a user to couple the attachment 400 to the prybar 300, and pick up or move the combination prybar 300 and attachment 400 without the attachment 400 inadvertently falling off of the prybar 300.

While the attachment is described as used in conjunction with a prybar, the attachment is suitable for use with other tools that may be used as a general lever, such as a pole, rod, crowbar, prybar, etc. Further, any of the features of the attachment 100 can be incorporated into the attachment 200 or 400, any of the features of the attachment 200 can be incorporated into the attachment 100 or 400, and any of the features of the attachment 400 can be incorporated into the attachment 100 or 200.

As used herein, the term “coupled” can mean any physical, electrical, magnetic, or other connection, either direct or indirect, between two parties. The term “coupled” is not limited to a fixed direct coupling between two entities.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of the inventors' contribution. The actual scope of the protection sought is intended to be defined in the following claims when viewed in their proper perspective based on the prior art.

What is claimed is:

1. An attachment for a prybar, the attachment comprising:
a base portion having a bottom surface and an interface surface opposite the bottom surface;
opposing first and second sides extending upwardly from the base portion and cooperatively forming a channel between the first and second sides that is adapted to receive the prybar; and
a fastener coupling the first and second sides together and extending across the channel.

2. The attachment of claim 1, wherein the first and second sides respectively include first and second apertures, and the fastener is disposed in the first and second apertures.

3. The attachment of claim 1, wherein the fastener includes opposing first and second ends respectively coupled to the first and second sides.

4. The attachment of claim 1, wherein each of the first and second sides includes upper and lower portions, wherein the upper portions are tapered.

5. The attachment of claim 4, wherein the first and second sides respectively include first and second apertures respectively disposed in the upper portions of the first and second sides.

6. The attachment of claim 4, wherein the lower portions are substantially rectangular in shape, and the upper portions are substantially triangular in shape.

7. The attachment of claim 1, wherein the bottom surface includes a serrated surface.

8. The attachment of claim 1, wherein the bottom surface includes a flat surface.

9. The attachment of claim 1, wherein the bottom surface is an arcuate surface.

10. The attachment of claim 1, wherein the interface surface is an arcuate surface.

11. The attachment of claim 1, wherein the interface surface is an flat surface.

12. The attachment of claim 1, wherein the base portion and the first and second sides are a single monolithic piece.

13. An attachment for a prybar, the attachment comprising:
a base portion having a bottom surface and an interface surface opposite the bottom surface;
opposing first and second sides extending upwardly from the base portion and cooperatively forming a channel between the first and second sides that is adapted to receive a prybar;
first and second recesses disposed in the respective first and second sides, wherein a first width is formed between the first and second sides at the first and second recesses, a second width is formed between the first and second sides at a remainder of the channel, wherein the first width is greater than the second width; and
a fastener coupling the first and second sides together and extending across the channel.

14. The attachment of claim 13, wherein the first and second sides respectively include first and second apertures, and the fastener is disposed in the first and second apertures.

15. The attachment of claim 13, wherein the fastener includes opposing first and second ends respectively coupled to the first and second sides.

16. The attachment of claim 13, wherein the first and second recesses extend from the base upward along the first and second sides.

17. The attachment of claim 13, wherein each of the first and second sides includes upper and lower portions, wherein the upper portion is tapered.

18. The attachment of claim 17, wherein the first and second sides respectively include first and second apertures respectively disposed in the upper portions of the first and second sides.

19. The attachment of claim 17, wherein the lower portions are substantially rectangular in shape, and the upper portions are substantially triangular in shape.

20. The attachment of claim 13, wherein the bottom surface includes a serrated surface.

21. The attachment of claim 13, wherein the bottom surface includes a flat surface.

22. The attachment of claim 13, wherein the bottom surface includes an arcuate surface.

23. The attachment of claim 13, wherein the interface surface is an arcuate surface.

24. The attachment of claim 11, wherein the interface surface is an flat surface.

25. The attachment of claim 13, wherein the base portion and the first and second sides are a single monolithic piece.
